(19) United States
(12) Patent Application Publication
(10) Pub. No.: US 2010/0138820 A1
(43) Pub. Date: Jun. 3, 2010

(54) Framework for Control Flow-Aware Processes

(76) Inventor: Shrinivas B. Joshi, Austin, TX (US)

Correspondence Address: HAMILTON & TERRILE, LLP - AMD, P.O. BOX 203518, AUSTIN, TX, 78720, US

(21) Appl. No.: 12/325,685

(22) Filed: Dec. 1, 2008

(51) Int. Cl. G06F 9/45

(52) U.S. Cl. 717/158

(57) ABSTRACT

An improved system and method are disclosed for processing Java program code. Java source code is annotated with a Module or a ControlFlow annotation. The Java source code is then compiled to produce Java bytecode, which in turn is compiled by a just-in-time compiler to produce native code, which retains the annotations. The native code with annotations is then executed. If a bug is identified during the execution of the native code, an associated Module is selected for debugging, followed by determining associated Java source code segments within the responsible control flow path. Debugging operations are then performed on the associated Java source code segments.

### BACKGROUND OF THE INVENTION

1. Field of the Invention

Embodiments of the invention relate generally to information processing systems. More specifically, embodiments of the invention provide an improved system and method for processing Java program code.

2. Description of the Related Art

Java is an object oriented programming language and environment that has gained wide acceptance in recent years. One aspect of Java is its portability, which has contributed to its popularity with developers of software applications. Java's approach to portability is to compile Java language code into Java bytecode, which is analogous to machine code, but is instead interpreted by a Java virtual machine (JVM) written specifically for the host computing platform. As a result, software applications written in Java can be written once, compiled once, and then run on any combination of hardware and operating system that supports a JVM.

However, interpreted programs typically run slower than programs that are compiled into native executables due to the processing overhead associated with interpreting bytecode. One approach to this issue is the implementation of a just-in-time (JIT) compiler that translates Java bytecode into native code the first time the code is executed and then caches the native code in memory. This results in a program that starts and executes faster than pure interpreted code at the cost of introducing compilation overhead during its initial execution.

The execution of a Java software application is typically monitored and controlled through the Java Debugging Interface (JDI) or the JVM Tools Interface (JVMTI), which provides a native interface for tools such as debuggers and profilers. However, debugging large scale Java applications can be challenging, especially for developers who do not have extensive knowledge of an application's underlying Java code flows. For example, manually stepping through Java code, segment by segment, can be cumbersome, tedious, and time consuming when a software bug exists somewhere in an extremely long code path. Known approaches to this issue include setting breakpoints in fewer relevant code sites instead of single stepping through the entirety of the code. While such approaches may lessen the complexity of debugging a Java application, they are of less value when the software bug exists at the junction of two or more code paths. Determining which of the code paths resulted in the bug requires successively debugging each code path until the origin or cause of the bug is found. In addition, the occurrence of a software bug may result in an unexpected code path, further complicating debugging efforts.

### SUMMARY OF THE INVENTION

An improved system and method are disclosed for processing Java program code. In various embodiments, a control flow annotation module is used to annotate Java source code to produce Java source code with annotations. In one embodiment, the Java source code annotations comprise a Module annotation. In another embodiment, the Java source code annotations comprise a ControlFlow annotation.

The Java source code with annotations is then compiled to produce Java bytecode, which retains the annotations to the source code. In one embodiment, the Java bytecode with annotations is then compiled into native code with a just-in-time (JIT) compiler, which likewise retains the annotations to the source code. The native code with annotations is then executed. In various embodiments, the execution of the native code with annotations is monitored with a control flow annotation module.

If a bug is identified during the execution of the native code, then a list of unique Module annotation names is accessed to determine associated Modules for debugging. An associated Module is then selected for debugging, followed by determining associated Java source code segments. Debugging operations are then performed on the associated Java source code segments. As an example, a bug may occur at the intersection of two different code paths, each associated with their respective Module. By determining which of the Modules caused the bug, the user can then selectively debug the Java source code segments within the responsible control flow path.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized block diagram illustrating an information processing system as implemented in accordance with an embodiment of the invention;

FIG. 2 is a simplified block diagram of a control flow annotation module as implemented in accordance with an embodiment of the invention;

FIG. 3 is a simplified block diagram of annotated Java code segments as implemented in accordance with an embodiment of the invention;

FIGS. 4a-b are a generalized flowchart of the operation of a control flow annotation module as implemented in accordance with an embodiment of the invention for the annotation of Java source code; and

FIG. 5 is a generalized flowchart of the operation of a control flow annotation module as implemented in accordance with an embodiment of the invention for the debugging of compiled Java code.

### DETAILED DESCRIPTION

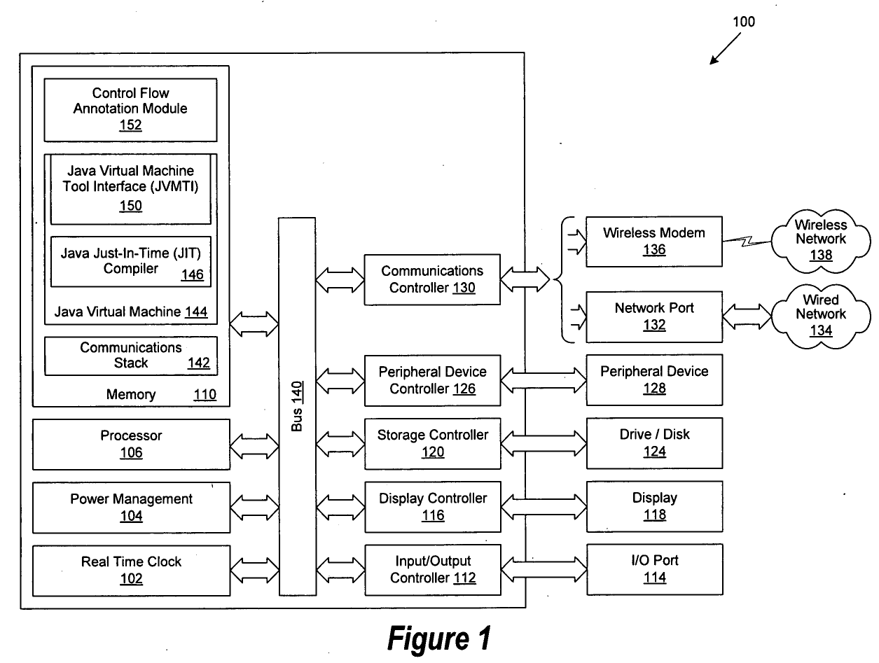

An improved system and method are disclosed for processing Java program code. FIG. 1 is a generalized block diagram illustrating an information processing system 100 as implemented in accordance with an embodiment of the invention. System 100 comprises a real-time clock 102, a power management module 104, a processor 106 and memory 110, all physically coupled via bus 140. In various embodiments, memory 110 comprises volatile random access memory (RAM), non-volatile read-only memory (ROM), non-volatile flash memory, or any combination thereof. In one embodiment, memory 110 also comprises communications stack 142, Java Virtual Machine 144 and control flow annotation module 152. The Java virtual machine 144 further comprises a just-in-time (JIT) compiler 146 and a Java Virtual Machine Tool Interface (JVMTI) 150.

Also physically coupled to bus 140 is an input/out (I/O) controller 112, further coupled to a plurality of I/O ports 114. In different embodiments, I/O port 114 may comprise a keyboard port, a mouse port, a parallel communications port, an RS-232 serial communications port, a gaming port, a universal serial bus (USB) port, an IEEE1394 (Firewire) port, or any combination thereof. Display controller 116 is likewise physically coupled to bus 140 and further coupled to display 118. In one embodiment, display 118 is separately coupled, such as a stand-alone, flat panel video monitor. In another embodiment, display 118 is directly coupled, such as a laptop computer screen, a tablet PC screen, or the screen of a personal digital assistant (PDA). Likewise physically coupled to bus 140 is storage controller 120 which is further coupled to mass storage devices such as a tape drive or hard disk 124. Peripheral device controller is also physically coupled to bus 140 and further coupled to peripheral device 128, such as a random array of independent disk (RAID) array or a storage area network (SAN).

In one embodiment, communications controller 130 is physically coupled to bus 140 and is further coupled to network port 132, which in turn couples the information processing system 100 to one or more physical networks 134, such as a local area network (LAN) based on the Ethernet standard. In other embodiments, network port 132 may comprise a digital subscriber line (DSL) modem, cable modem, or other broadband communications system operable to connect the information processing system 100 to network 134. In these embodiments, network 134 may comprise the public switched telephone network (PSTN), the public Internet, a corporate intranet, a virtual private network (VPN), or any combination of telecommunication technologies and protocols operable to establish a network connection for the exchange of information.

In another embodiment, communications controller 130 is likewise physically coupled to bus 140 and is further coupled to wireless modem 136, which in turn couples the information processing system 100 to one or more wireless networks 138. In one embodiment, wireless network 138 comprises a personal area network (PAN), based on technologies such as Bluetooth or Ultra Wideband (UWB). In another embodiment, wireless network 138 comprises a wireless local area network (WLAN), based on variations of the IEEE 802.11 specification, often referred to as WiFi. In yet another embodiment, wireless network 138 comprises a wireless wide area network (WWAN) based on an industry standard including two and a half generation (2.5G) wireless technologies such as global system for mobile communications (GPRS) and enhanced data rates for GSM evolution (EDGE). In other embodiments, wireless network 138 comprises WWANs based on existing third generation (3G) wireless technologies including universal mobile telecommunications system (UMTS) and wideband code division multiple access (W-CDMA). Other embodiments also comprise the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies.

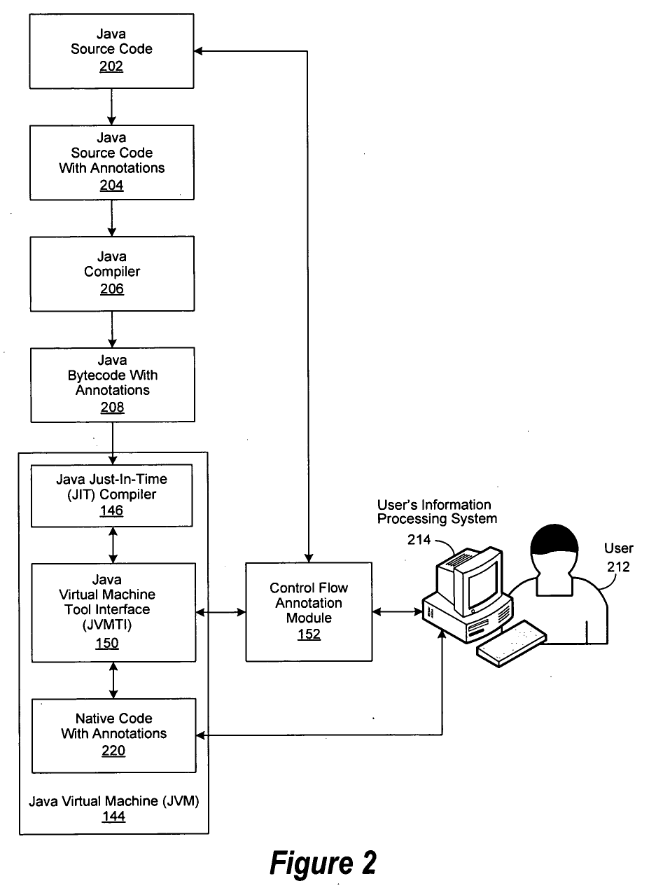

FIG. 2 is a simplified block diagram of control flow annotation module as implemented in accordance with an embodiment of the invention. In various embodiments, a control flow annotation module 152 is used to annotate Java source code 202 to produce Java source code with annotations 204. Skilled practitioners of the art will be familiar with the annotation of Java source code, which is a special form of syntactic metadata that can be added to Java source code. Java classes, methods, variables, parameters and packages may be annotated. When compiled, the Java compiler conditionally stores annotation metadata in class files if the annotation has a RetentionPolicy of CLASS or RUNTIME. At runtime, the Java Virtual Machine (JVM) can look for the annotation metadata to determine how to interact with various program elements or to change their behavior. In various embodiments, the Java source code annotations may comprise a Module annotation or a ControlFlow annotation as described in greater detail herein.

The Java source code with annotations 204 is then compiled by a Java compiler 206 to produce Java bytecode 208, which retain the annotations to the source code 204. In this embodiment, Java program code debugging operations are then begun by compiling the Java bytecode with annotations 208 into native code with annotations 220 with a just-in-time (JIT) compiler 146. In various embodiments, the JIT compiler 146 conforms to an annotation RetentionPolicy to determine which annotations are to be included in the native code with annotations 220. In these embodiments, the annotation RetentionPolicy comprises a CLASS and RUNTIME annotation RetentionPolicy. The native code with annotations 220 is then executed by the JVM 144. In various embodiments, the execution of the native code with annotations 220 is monitored with a control flow annotation module 152. In these various embodiments, the control flow annotation module 152 monitors the execution of the native code with annotations 220 through a JVM Tool Interface (JVMTI) 150.

If a bug is identified during the execution of the native code with annotations 220, then the list of unique Module annotation names is accessed to determine associated Modules for debugging. An associated Module is then selected for debugging, followed by determining associated Java source code segments. In one embodiment, one or more Modules associated with the bug are automatically selected from the list of unique Module annotation names during the execution of the native code for debugging. In another embodiment, one or more Modules associated with the bug are manually selected from the list of unique Module annotation names during the execution of the native code for debugging. Debugging operations are then performed on the associated Java source code segments. As an example, a bug may occur at the intersection of two different code paths, each associated with their respective Module. By determining which of the Modules caused the bug, the user 212, using their information processing system 214, can then selectively debug the Java source code segments within the responsible control flow path. Those of skill in the art will realize that the invention is equally applicable to other Java code processing operations, such as logging, profiling, and tracing. Accordingly, the foregoing is not intended to limit the scope, spirit, or intent of the invention.

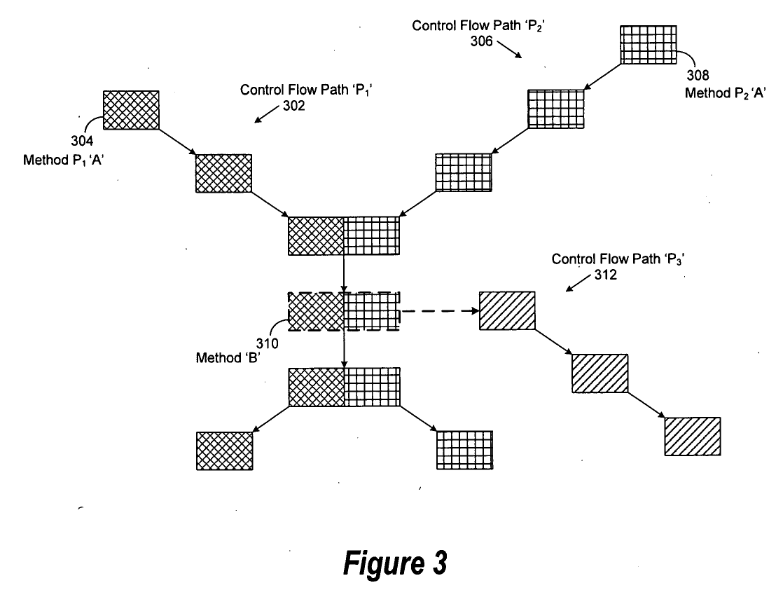

FIG. 3 is a simplified block diagram of annotated Java code segments as implemented in accordance with an embodiment of the invention. In this embodiment, a Java software application comprises two different control flow paths, ‘P₁’ 302 and ‘P₂’ 306. Each block within the two different control flow paths, ‘P₁’ 302 and ‘P₂’ 306 indicates a method or function within the application code and the arrows connecting the blocks indicate caller-callee relationships. Each of the blocks is annotated with Module or ControlFlow annotations as described in greater detail herein.

Different program inputs lead to one of the two control flow paths, ‘P₁’ 302 and ‘P₂’ 306 being taken by the application. During debugging, the occurrence of a bug is identified at method ‘B’ 310 due to a variable value that was incorrectly initialized either at method ‘P₁A’ 304 or ‘P₂A’ 308. Furthermore, the incorrect variable value has resulted in the application following an unexpected control flow path ‘P₃’ 312. It will be appreciated by those of skill in the art that tracing the cause of the bug occurring at method ‘B’ 310 would ordinarily be tedious, time consuming, and error-prone, especially if a user has limited knowledge of the possible code paths within the software application.

However, each of the code segments within the two control flow paths, ‘P₁’ 302 and ‘P₂’ 306 have been annotated with Module or ControlFlow annotations. A Module (e.g., method ‘P₁A’ 304 or ‘P₂A’ 308) is then selected for debugging, followed by determining associated Java source code segments within its associated control flow path (e,g., ‘P₁’ 302, ‘P₂’ 306). Debugging operations are then performed on the associated Java source code segments. The user can then selectively debug the Java source code segments within the responsible control flow path.

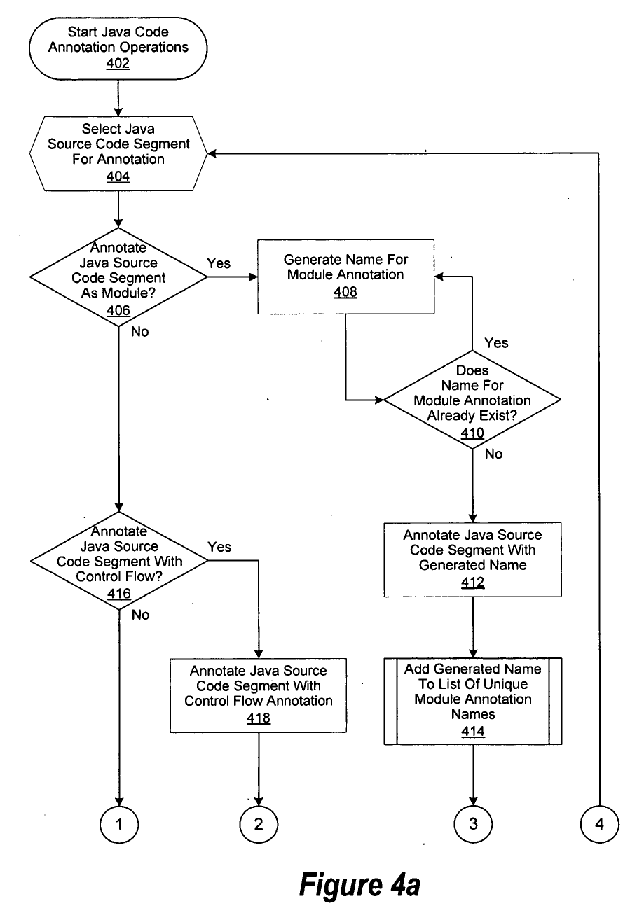

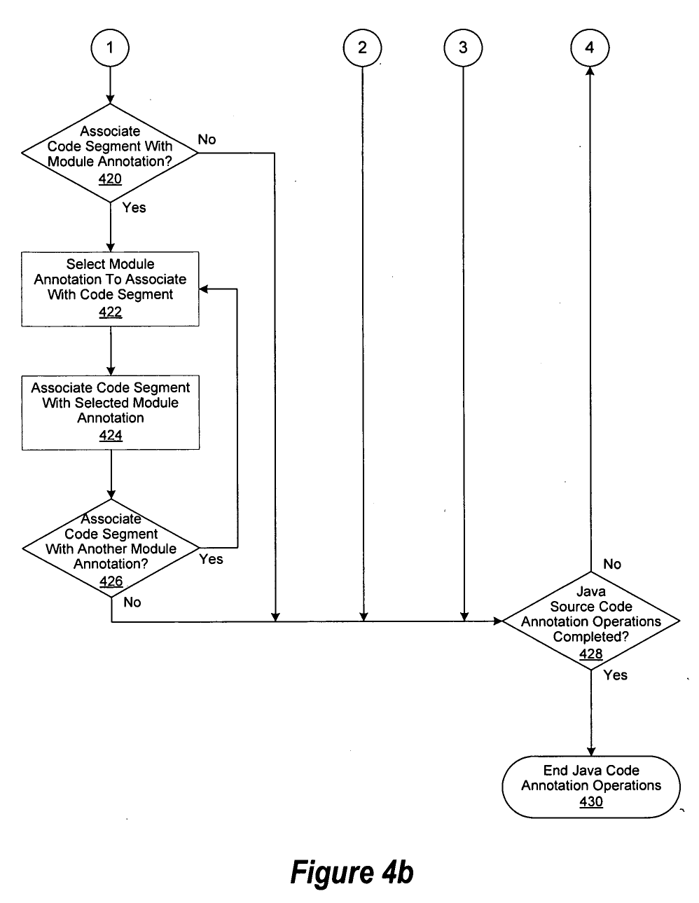

FIGS. 4a-b are a generalized flow chart of the operation of a control flow annotation module as implemented in accordance with an embodiment of the invention for the annotation of Java source code. In this embodiment, Java code annotation operations are begun in block 402 followed by the selection of a Java source code segment for annotation in step 404. Those of skill in the art will be familiar with the annotation of Java source code, which is a special form of syntactic metadata that can be added to Java source code. Java classes, methods, variables, parameters and packages may be annotated. When compiled, the Java compiler conditionally stores annotation metadata in class files if the annotation has a RetentionPolicy of CLASS or RUNTIME. At runtime, the Java Virtual Machine (JVM) can look for the annotation metadata to determine how to interact with various program elements or to change their behavior.

A determination is made in step 406 whether to annotate the Java source code segment with a Module annotation. As used herein, a Module annotation refers to metadata that references a Java code segment to a predetermined functionality within a Java software application. For instance, examples of Modules in a Java Virtual Machine (JVM) application may include “Garbage Collection,” “JIT,” “JVMTI,” “Object Allocation,” etc. In various embodiments, the Module annotation is a single-element annotation with a fixed and predetermined name. For example:

/**
* Annotation type definition for application modules
*/
public @interface Module{
String value( );
}
/**
* Example Module annotation
*/
@Module (“Garbage Collection”)
public void InitGargbageCollection( ) { .... }

In these embodiments, Module annotations are unique and are not duplicated within the entirety of a given Java software application. However, an individual code segment may be associated with multiple Module annotations. For example, there can only be one “Garbage Collection” Module annotation within in the entirety of a Java software application, yet the method InitGarbageCollection( ) could be associated with other Module annotations such as “JVMTI”. For example:

/**
* Example Module annotation
*/
@Module (“Garbage Collection”)
@Module(“JVMTI”)
public void InitGarbageCollection( ) { .... }

If it is determined in step 406 to annotate the Java source code segment with a Module annotation, then a name for the Module annotation is generated in step 408. A determination is then made in step 410 whether the generated name currently exists on a list of unique Module annotation names. If so, then the process repeated, proceeding with step 408 to select another name for the Module annotation. Otherwise, the generated name is used in step 412 to annotate the Java source code segment with the Module annotation and the generated name is added to the list of unique Module annotation names in step 414. A determination is then made in step 428 whether Java source code annotation operations are completed. If not, the process continues, proceeding with step 404. Otherwise, Java source code annotation operations are ended in step 430.

However, if it is determined in step 406 to not annotate the Java source code segment with a Module annotation, then a determination is made in step 416 whether to annotate the Java source code segment with a ControlFlow annotation. As used herein, a ControlFlow annotation defines possible code paths within a Java software application. It likewise defines components of Java software application code that can affect the behavior of a particular code segment. For example, if method InitGarbageCollection( ) calls InitGarbageCollectionAlgorithm( ), then the InitGarbageCollectionAlgorithm( ) method is annotated with a corresponding ControlFlow annotation. Skilled practitioners of the art will realize that the behavior of a Java software application can likewise be affected by values of static variables and objects initialized from outside the scope of a particular Module. Accordingly, in various embodiments, the ControlFlow annotation comprises three elements; Callers( ), Objects( ), and StaticVariables( ). In one embodiment, the Callers( ) elements defines all possible callers that can pass control to a predetermined code segment. In another embodiment, the Objects( ) element defines instances of classes that can affect behavior of a particular code segment. In yet another embodiment, the StaticVariables( ) element defines possible static variables that can affect behavior of a predetermined code segment.

For example:

| | |
|---|---|
| /** | |
| * Annotation type definition for defining code paths | |
| */ | |
| public @interface ControlFlow{ | |
| String[ ] Callers( ); | |
| String[ ] StaticVariable( ); | |
| Object[ ] Objects( ); | |
| } | |
| /** | |
| * Example Module annotation | |
| */ | |
| @Module (“Garbage Collection”) | |
| public void InitGargbageCollection( ) { | |
| InitGarbageCollectionAlgorithm( ); | |
| . . . . | |
| . . . . | |
| } | |
| /** | |
| * Example ControlFlow annotation | |
| */ | |
| @ControlFlow ( | |
| Callers = {“Garbage Collection”} | |
| StaticVariables | = |
| {“jvm.hotspot.ergonimics.systemConfiguration”} | |
| Objects = {“jvm.hotspot.jvmFlags.GCAlgorithm”} | |
| ) | |
| public void InitGargbageCollectionAlgorithm( ) { | |
| if((jvm.hotspot.ergonomics.systemConfiguration | == |
| “QuadCoreAMDProcessorSystem”) | && |
| (jvm.hotspot.jvmFlags.GCAlgorithm != SerialGC)) | |
| { | |
| GarbageCollectionAlgorithm = “ParallelGC”; | |
| } | |
| } | |

In various embodiments, the ControlFlow annotation can be modified to accommodate other code components that can affect code segment behavior. In one embodiment, one or more code segments are manually annotated with ControlFlow annotations by a user. In another embodiment, one or more code segments are automatically annotated with ControlFlow annotations by an automated annotation builder. As an example, an automated annotation builder may be a tool provided as part of an integrated development environment (IDE).

If it is determined in step 416 to annotate the Java source code segment with a ControlFlow annotation, then it is so annotated in step 418. A determination is then made in step 428 whether Java source code annotation operations are completed. If not, the process continues, proceeding with step 404. Otherwise, Java source code annotation operations are ended in step 430. However, if it is determined in step 416 to not annotate the Java source code segment with a ControlFlow annotation, then a determination is made in step 420 whether to associate the code segment with a Module annotation. If not, then a determination is then made in step 428 whether Java source code annotation operations are completed. If not, the process continues, proceeding with step 404. Otherwise, Java source code annotation operations are ended in step 430.

However, if it is determined in step 420 to associate the code segment with a Module annotation, then a Module annotation is selected from the list of unique Module annotations in step 422. The code segment is then associated with the selected Module annotation in step 424. A determination is then made in step 42 whether to associate the code segment with another Module annotation. If so, the process continues, proceeding with step 422. Otherwise, a determination is made in step 428 whether Java source code annotation operations are completed. If not, the process continues, proceeding with step 404. Otherwise, Java source code annotation operations are ended in step 430.

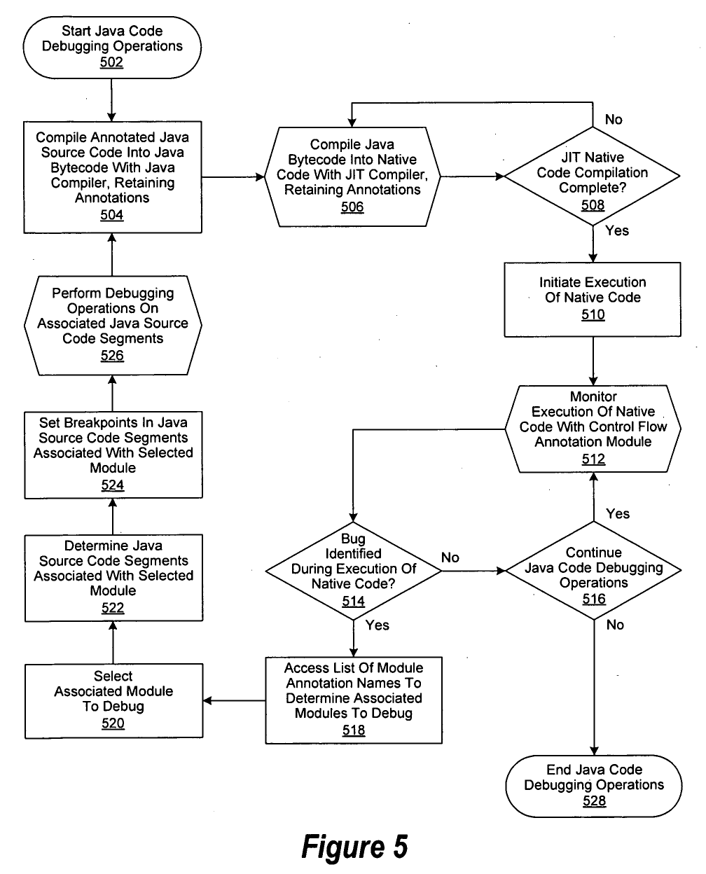

FIG. 5 is a generalized flow chart of the operation of a control flow annotation module as implemented in accordance with an embodiment of the invention for the debugging of compiled Java code. In this embodiment, Java code debugging operations are begun in step 502. Java source code is then compiled into Java bytecode with a Java compiler in step 504. In one embodiment, the Module and ControlFlow annotations described in greater detail herein are retained in the Java bytecode. The Java bytecode is then compiled into native code with a Just In Time (JIT) compiler in step 506. In one embodiment, the Module and ControlFlow annotations described in greater detail herein are likewise retained in the native code. In various embodiments, the retention policy for the Module and ControlFlow annotations conforms to the Java meta-annotation@Retention.

A determination is made in step 508 whether JIT compilation is complete. If not, then the process continues, proceeding with step 506. Otherwise, execution of the native code is initiated in step 510 and then monitored with a control flow annotation module in step 512. A determination is then made in step 514 whether a bug has been identified during the execution of the native code. In one embodiment, the bug is automatically identified during the execution of the native code. In another embodiment, the bug is manually identified during the execution of the native code.

If so, then the list of unique Module annotation names is accessed in step 518 to determine associated Modules for debugging. An associated Module is then selected for debugging in step 520, followed by determining Java source code segments associated with the selected Module in step 522. Breakpoints are then set in the associated Java source code segments in step 524. Once the break points are set, debugging operations are performed on the associated Java source code segments in step 504 and the process continues, proceeding with step 504. As an example, a bug may occur at the intersection of two different code paths, each associated with their respective Module. By determining which of the Modules caused the bug, the user can then selectively set breakpoints in the Java source code segments within the responsible control flow path. Once set, debugging operations can then be performed on those Java source code segments, thereby simplifying the debugging process.

However, if it is determined in step 514 that a bug has not been identified during the execution of the native code, then a determination is made in step 516 whether to continue Java code debugging operations. If so, then the process continues, proceeding with step 512. Otherwise, Java code debugging operations are ended in step 528. Those of skill in the art will realize that the invention is equally applicable to other Java code processing operations, such as logging, profiling, and tracing. Accordingly, the foregoing is not intended to limit the scope, spirit, or intent of the invention.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A method for debugging Java program code, comprising:
annotating Java source code with a control flow annotation module, wherein said annotations are retained in compiled code compiled from said Java source code; and
debugging said compiled code, wherein at least one of said annotations are provided by said control annotation module in response to the performance of a debugging operation.

2. The method of claim 1, wherein said annotations are applied to a predetermined segment of said Java source code.

3. The method of claim 2, wherein said annotations comprise a Module annotation.

4. The method of claim 3, wherein an individual said predetermined segment of Java source code is associated with a plurality of said Module annotations.

5. The method of claim 2, wherein said annotations comprise a ControlFlow annotation.

6. The method of claim 5, wherein said ControlFlow annotation comprises a Callers element defining a first said predetermined Java source code segment that can pass control to a second said predetermined Java source code segment.

7. The method of claim 5, wherein said ControlFlow annotation comprises an Objects element defining instances of classes that can affect the behavior of a said predetermined Java source code segment.

8. The method of claim 5, wherein said ControlFlow annotation comprises a Static Variables element defining static variables that can affect the behavior of a said predetermined Java source code segment.

9. The method of claim 4, wherein said compiled code comprises compiled Java bytecode.

10. The method of claim 4, wherein said compiled code comprises compiled native code.

11. A system for debugging Java program code, comprising:
a control flow annotation module operable to:
annotate Java source code, wherein said annotations are retained in compiled code compiled from said Java source code; and
provide at least one of said retained annotations in response to the performance of a debugging operation.

12. The system of claim 1, wherein said annotations are applied to a predetermined segment of said Java source code.

13. The system of claim 12, wherein said annotations comprise a Module annotation.

14. The system of claim 13, wherein an individual said predetermined segment of Java source code is associated with a plurality of said Module annotations.

15. The system of claim 12, wherein said annotations comprise a ControlFlow annotation.

16. The system of claim 15, wherein said ControlFlow annotation comprises an Objects element defining instances of classes that can affect the behavior of a said predetermined Java source code segment.

17. The system of claim 15, wherein said ControlFlow annotation comprises an Objects element defining instances of classes that can affect the behavior of a said predetermined Java source code segment.

18. The system of claim 15, wherein said ControlFlow annotation comprises a Static Variables element defining static variables that can affect the behavior of a said predetermined Java source code segment.

19. The system of claim 1, wherein said compiled code comprises compiled Java bytecode.

20. The system of claim 1, wherein said compiled code comprises compiled native code.
